(19) United States
(12) Patent Application Publication
(10) Pub. No.: US 2024/0087290 A1
(43) Pub. Date: Mar. 14, 2024

(54) SYSTEM AND METHOD FOR ENVIRONMENTAL EVALUATION

(71) Applicant: Cape Analytics, Inc., Palo Alto, CA (US)

(72) Inventors: Ryan Hedges, Palo Alto, CA (US); Giacomo Vianello, Palo Alto, CA (US); Sarah Cebulski, Palo Alto, CA (US); Joshua A. Magee, Palo Alto, CA (US)

(21) Appl. No.: 18/509,640

(22) Filed: Nov. 15, 2023

Related U.S. Application Data
(63) Continuation-in-part of application No. 17/841,981, filed on Jun. 16, 2022.
(60) Provisional application No. 63/211,120, filed on Jun. 16, 2021.
(60) Provisional application No. 63/250,031, filed on Sep. 29, 2021.
(60) Provisional application No. 63/250,018, filed on Sep. 29, 2021.
(60) Provisional application No. 63/250,045, filed on Sep. 29, 2021.
(60) Provisional application No. 63/250,039, filed on Sep. 29, 2021.
(60) Provisional application No. 63/282,078, filed on Nov. 22, 2021.

(51) Int. Cl. G06V 10/764; G06V 10/26; G06V 10/44; G06V 10/774; G06V 10/94; G06V 20/10; G06V 20/70

(52) U.S. Cl. CPC G06V 10/764; G06V 10/26; G06V 10/44; G06V 10/774; G06V 10/945; G06V 20/176; G06V 20/188; G06V 20/70; G01W 1/00

(57) ABSTRACT

A method for environmental evaluation of a property (e.g., determining a hazard score for a property) can include: determining a property; determining measurements for the property; determining attribute values for the property; determining an evaluation metric (e.g., hazard score) for the property; and optionally training one or more environmental evaluation models.

### CROSS-REFERENCE TO RELATED APPLICATIONS

This application is a continuation-in-part of U.S. application Ser. No. 17/841,981 filed 16 Jun. 2022, which claims the benefit of U.S. Provisional Application number 63/211,120 filed 16 Jun. 2021, U.S. Provisional Application No. 63/250,031 filed 29 Sep. 2021, U.S. Provisional Application No. 63/250,018 filed 29 Sep. 2021, U.S. Provisional Application No. 63/250,045 filed 29 Sep. 2021, U.S. Provisional Application No. 63/250,039 filed 29 Sep. 2021, and U.S. Provisional Application No. 63/282,078 filed 22 Nov. 2021, each of which is incorporated in its entirety by this reference.

### TECHNICAL FIELD

This invention relates generally to the image analysis field, and more specifically to a new and useful method in the image analysis field.

### BRIEF DESCRIPTION OF THE FIGURES

FIG. 1 is a schematic representation of a variant of the method.

FIG. 2 depicts an embodiment of the method, including determining an evaluation metric (e.g., hazard score).

FIG. 3 depicts an example of determining an evaluation metric.

FIG. 4 depicts an example of determining a mitigated vulnerability score.

FIG. 5 depicts an example of model training.

FIG. 6A depicts a first illustrative example of training data.

FIG. 6B depicts a second illustrative example of training data

FIG. 7 depicts an example of attribute selection.

FIG. 8 depicts an example of binning an environmental evaluation model output.

### DETAILED DESCRIPTION

The following description of the embodiments of the invention is not intended to limit the invention to these embodiments, but rather to enable any person skilled in the art to make and use this invention.

### 1. Overview

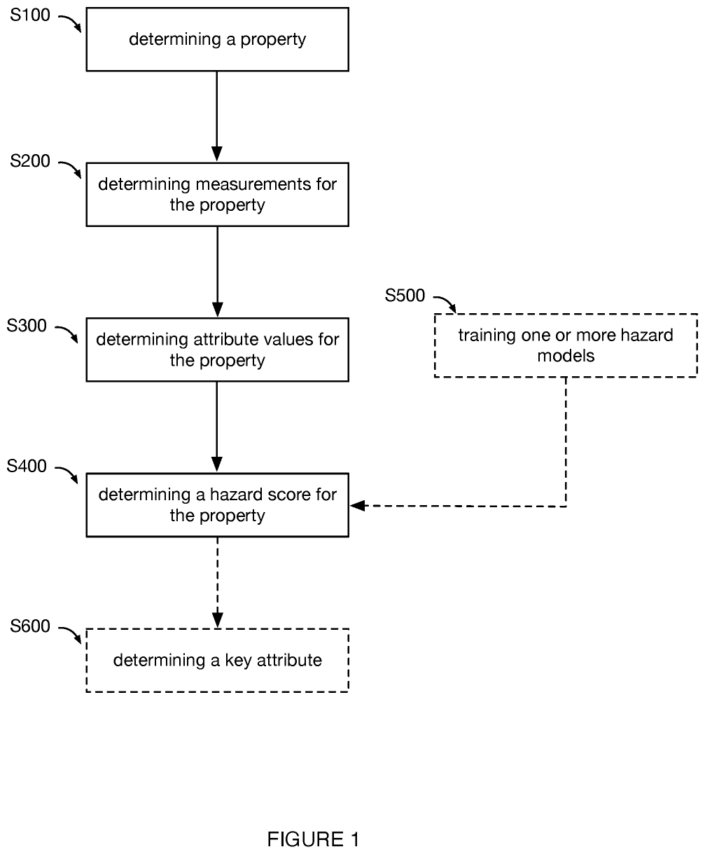

As shown in FIG. 1, the method for environmental evaluation (e.g., determining a hazard score of a property) can include: determining a property (e.g., geographic location) S100; determining measurements for the property S200; determining attribute values for the property S300; and determining an evaluation metric (e.g., hazard score) for the property S400.

For a given property, the method can function to determine an evaluation metric associated with a hazard, such as wildfire, flood, hail, wind, tornadoes, or other hazards. The hazards are preferably environmental hazards and/or widespread hazards (e.g., that encompass more than one property), but can alternatively be man-made hazards, property-specific hazards, and/or other hazards (e.g., house fire).

The resultant information (e.g., evaluation metric, etc.) can be used as an input in one or more property models, such as an automated valuation model, a property loss model, and/or any other suitable model; be provided to an endpoint (e.g., shown to a property buyer); and/or otherwise used.

### 2. Examples

In examples, the method can include: receiving one or more property identifiers (e.g., addresses, geofence, etc.) from a client, retrieving images depicting the property(s) (e.g., from a database), and extracting attribute values for each of a set of property attributes from the images. The property attributes are preferably structural attributes, such as the presence or absence of a property component (e.g., roof, vegetation, etc.), property component geometric descriptions (e.g., roof shape, slope, complexity, building height, living area, structure footprint, etc.), property component appearance descriptions (e.g., condition, roof covering material, etc.), and/or neighboring property components or geometric descriptions (e.g., presence of neighboring structures within a predetermined distance, etc.), but can additionally or alternatively include other attributes, such as built year, number of beds and baths, or other descriptors. One or more evaluation metrics (e.g., vulnerability score, risk score, regional exposure score, etc.) can then be calculated for the property.

A vulnerability score for the property (e.g., indicative of the vulnerability of the property to a given hazard) can then be determined based on the property attribute values, using a trained vulnerability model. In specific examples, the vulnerability score excludes regional risk (e.g., the overall exposure of the geographic region containing the property to the given hazard), is independent of the property's regional location, and/or is specific to the property's physical attributes. In these specific examples, two properties with the same attribute values that are located in different geographic locations could have the same vulnerability score.

A risk score for the property (e.g., hazard risk score) can additionally or alternatively be determined based on the property attribute values and a regional exposure score (e.g., regional risk score), using a trained risk model.

The risk model and/or vulnerability model can be trained on historical insurance claim data, such that the respective scores are associated with a probability of or expected: claim occurrence, claim loss, damage, claim rejection, and/or any other metric.

The method additionally can output and/or be used to determine: a key attribute influencing the evaluation metric, a set of mitigation measures for the property (e.g., high-impact mitigation measures that result in a change in the evaluation metric, wherein the change is above a threshold amount), a mitigated evaluation metric indicative of the effect of mitigation measures (e.g., by adjusting or setting attribute values associated with mitigable property attributes to a predetermined value), groups of properties (e.g., targeted property lists with low vulnerability in a high hazard exposure risk region; mitigatable properties; etc.), and/or any other output. However, property-specific hazard exposure can be otherwise determined.

### 3. Technical Advantages

The technology described herein can confer one or more technical advantages over conventional technologies.

First, variants of the method can determine or infer property-specific vulnerability to a given hazard (e.g., a score representative of the property's susceptibility to the damaging effects of a hazard). This can be determined irrespective of the likelihood that the property's geographic region will experience the hazard (e.g., without using weather and/or hazard data, without property using regional location information, etc.). For example, the inventors have discovered that roof geometry features, such as roof complexity, roof geometry type, and/or roof area, can drive the probability of damage being sustained and how much damage is sustained from a hailstorm or wildfire event given the occurrence of a hazard event. This can eliminate confounding factors as well as provide a more objective property vulnerability metric. Variants of the method can thus segment properties within a given region (e.g., with similar or varied hazard exposure risks) that otherwise would be grouped together.

Second, instead of a property merely inheriting a region's hazard exposure risk, this method can enable a property-specific risk score to be determined, which provides more accurate risk estimates. In variants, this can be accomplished by using both a regional exposure score as well as property-specific attribute values. For example, while wooden structures with complex roof geometries can be highly vulnerable to wildfires, those particular attribute values in an urban environment (e.g., San Francisco) may have a low overall risk score, since the urban environment may have a low regional exposure risk. In another example, this technology can enable lower-risk properties in high-exposure-risk areas to be identified and treated (e.g., insured, maintained, valued, etc.) differently from higher-risk properties in the same region.

Third, variants of the method can determine or infer a claim filing probability, expected claim frequency, and/or expected loss severity for a property (e.g., within a given timeframe). In addition to or instead of evaluating hazard exposure risk based on property location (e.g., based on historical weather data), the method can include training a model to ingest property-specific attribute values to estimate the probability that a claim associated with the property (e.g., insurance claim, aid claim, etc.) will be submitted and accepted and/or estimate other claim parameters (e.g., loss amount, etc.). The inventors have discovered that, by using property-specific signals (e.g., training labels), models can be trained to predict the risk on an individual-property basis, instead of attempting to infer per-property risk based on weather and/or population data.

Fourth, variants of the method can analyze the effect of mitigation measures for a property, including determining the effect of one or more mitigation measures on the property vulnerability to a given hazard. For example, the method can use a mitigated vulnerability score to determine whether a given mitigation measure or measures will be effective and/or worth spending resources on, to determine which mitigations to recommend, to identify a set of properties (e.g., for insurance, maintenance, valuation etc.), to determine whether community mitigation measures should be implemented, and/or for any other use. In variants, the method can also confirm whether the mitigations have been executed (e.g., based on attribute values extracted from subsequent remote imagery of the property).

Fifth, variants of the method can use interpretability and/or explainability methods to increase the accuracy of the environmental evaluation model, to provide additional information to a user (e.g., a summary of the most impactful property-specific attributes on a given evaluation metric), to decrease model bias, and/or for any other function. In an example, interpretability and/or explainability methods can be used to validate and/or otherwise analyze an attribute selection performed using an attribute selection model (e.g., wherein values for the selected attributes are ingested by an environmental evaluation model). This analysis can be integrated with domain knowledge (e.g., whether an attribute's effect on the evaluation metric makes sense) to adjust the attribute selection and/or to adjust the environmental evaluation model.

Sixth, variants of the method can use multiple score types for a given property. For example, subsets of properties can be identified using a combination of (e.g., a comparison between): unmitigated vulnerability scores, mitigated vulnerability scores, regional exposure scores, risk scores, and/or any other evaluation metrics. In variants, these score combinations can identify distinct subsets of properties that would otherwise be grouped together, wherein the distinct subsets can be treated differently downstream (e.g., for insurance, valuation, etc.).

Seventh, in variants, the environmental evaluation model implemented in the method can be trained on a type of claim data. For example, the model can be trained on claim frequency (e.g., a binary claim occurrence within a given timeframe) rather than loss amount. This can function to diminish bias in the model (e.g., due to confounding factors such as property value, income level, etc.).

However, further advantages can be provided by the system and method disclosed herein.

### 4. Method

The method for environmental evaluation (e.g., determining a hazard score of a property) can include: determining a property (e.g., geographic location) S100; determining measurements for the property S200; determining attribute values for the property S300; determining an evaluation metric (e.g., hazard score) for the property S400; optionally training an environmental evaluation model (e.g., hazard model) S500; and optionally determining a key attribute S600.

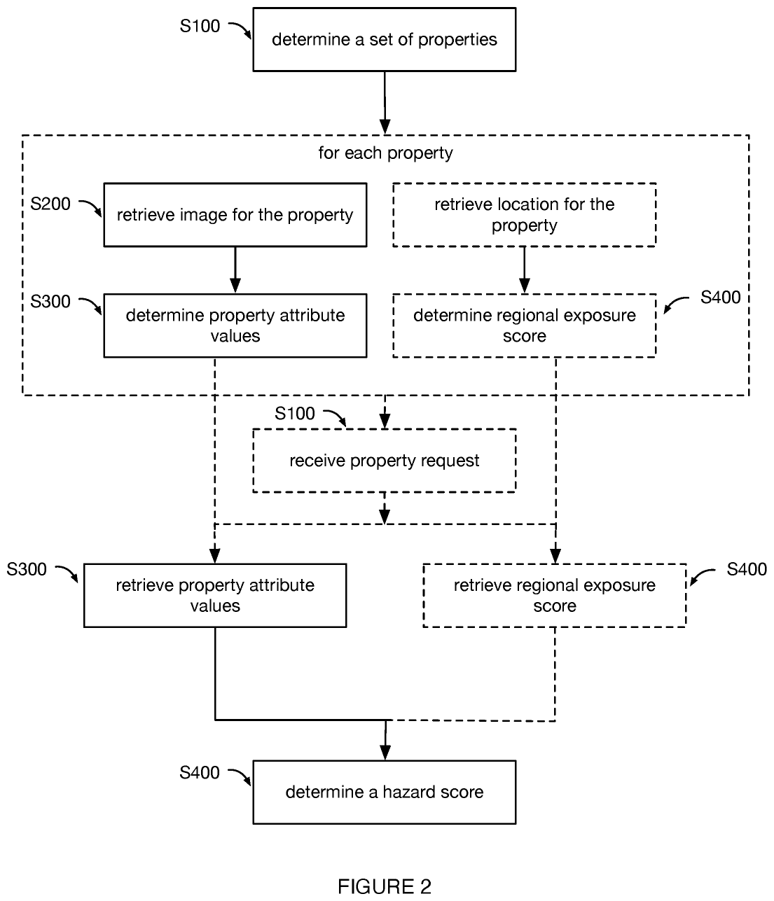

The method can be performed for a single property, iteratively for a list of properties, for a group of properties as a whole (e.g., for the properties as a batch), for a property class, responsive to receipt of a request for an evaluation metric for a given property, responsive to receipt of a new image depicting the property, and/or at any other suitable time. The hazard information (e.g., attribute values, evaluation metric, etc.) can be stored in association with the property identifier for the respective property. All or parts of the hazard information can be determined: in real or near-real time; responsive to a request; pre-calculated; asynchronously; and/or at any other time. The evaluation metric can be calculated in response to a request, be pre-calculated, and/or calculated at any other suitable time. The evaluation metric(s) can be returned (e.g., sent to a user) in response to the request, published, and/or otherwise presented. An example is shown in FIG. 2.

The method can be performed by a system including a set of attribute models (e.g., configured to extract values for one or more attributes), and a set of environmental evaluation models (e.g., configured to determine an evaluation metric for one or more properties). The system can additionally or alternatively include or access: measurement data sources (e.g., third-party APIs, measurement databases, etc.), property data sources (e.g., third-party APIs, parcel databases, property attribute databases, etc.), claims data sources (e.g., insurance claim data sources, aid claim data sources, etc.), and/or any other suitable data source. The system can be executed on a remote computing system, distributed computing system, local computing system, and/or any other suitable computing system. The system can be programmatically accessed (e.g., via an API), accessed via an interface (e.g., user interface), and/or otherwise accessed. However, the method can be executed by any other system.

Determining a property S100 can function to identify a property (e.g., geographic location) for hazard analysis, such as attribute value determination, for evaluation metric calculation, and/or for environmental evaluation model training. S100 can be performed before S200, after S300 (e.g., where attribute values have been previously determined for each of a set of properties), during S500, and/or at any other time.

The property (e.g., geographic location) can be or include: a parcel (e.g., land), a property component or set or segment thereof, and/or otherwise defined. For example, the property can include both the underlying land and improvements (e.g., built structures, fixtures, etc.) affixed to the land, only include the underlying land, or only include a subset of the improvements (e.g., only the primary building). Property components can include: built structures (e.g., primary structure, accessory structure, deck, pool, etc.); subcomponents of the built structures (e.g., roof, siding, framing, flooring, living space, bedrooms, bathrooms, garages, foundation, HVAC systems, solar panels, slides, diving board, etc.); permanent improvements (e.g., pavement, statutes, fences, etc.); temporary improvements or objects (e.g., trampoline); vegetation (e.g., tree, flammable vegetation, lawn, etc.); land subregions (e.g., driveway, sidewalk, lawn, backyard, front yard, wildland, etc.); debris; and/or any other suitable component. The property and/or components thereof are preferably physical, but can alternatively be virtual.

The property can be identified by one or more property identifiers. A property identifier (property ID) can include: geographic coordinates, an address, a parcel identifier, a block/lot identifier, a planning application identifier, a municipal identifier (e.g., determined based on the ZIP, ZIP+4, city, state, etc.), and/or any other identifier. The property identifier can be used to retrieve property data, such as parcel information (e.g., parcel boundary, parcel location, parcel area, etc.), property measurements, and/or other data. The property identifier can additionally or alternatively be used to identify a property component, such as a primary building or secondary building, and/or otherwise used.

S100 can include determining a single property, determining a set of properties, and/or any other suitable number of properties. In a first variant, the property can be determined via an input request including a property identifier. The received input can be communicated via a user device (e.g., smartphone, tablet, computer, user interface, etc.), an API, GUI, third-party system, and/or any suitable system (e.g., from a requestor, a user, etc.). In a second variant, the property can be extracted from a map, image, geofence, and/or any other representation of a geographic region. In this variant, each property within the geographic region can be identified (e.g., corresponding to a predetermined region exposed to a given hazard, based on an address registry, database, image segmentation, based on claim data, etc.), wherein all or parts of the method is executed for each identified property.

In examples, the property can be determined using the methods disclosed in U.S. application Ser. No. 17/228,360 filed 12 Apr. 2021, which is incorporated in its entirety by this reference. However, the property can be otherwise determined.

Determining measurements for the property S200 can function to determine property-specific data (e.g., an image or other visual representation) for the property. The measurements can be determined after S100, iteratively for a list of properties, in response to a request, when updated or new region or property imagery is available, when one or more property components and/or attributes are added (e.g., to a database), during environmental evaluation model training S500, and/or at any other suitable time.

The measurements can have an associated sampling timestamp that is: before a hazard event (e.g., before a hailstorm, tornado, flood, etc.), after a hazard event, during a hazard event, and/or have any other temporal relationship to a hazard event of interest (e.g., a hazard event having a desired hazard class, a specific hazard event, etc.).

One or more property measurements can be determined for a given property. A property measurement preferably depicts the property, but can additionally or alternatively depict the surrounding geographic region, adjacent properties, and/or other factors.

The property measurement can be: 2D, 3D, and/or have any other set of dimensions. Examples of property measurements can include: images, surface models (e.g., digital surface models (DSM), digital elevation models (DEM), digital terrain models (DTM), etc.) point clouds (e.g., generated from LIDAR, RADAR, stereoscopic imagery, etc.), virtual models (e.g., geometric models, mesh models), audio, video, and/or any other suitable measurement. Examples of images that can be used include: an image captured in RGB, hyperspectral, multispectral, black and white, grayscale, panchromatic, IR, NIR, UV, thermal, and/or captured using any other suitable wavelength; images with depth values associated with one or more pixels (e.g., DSM, DEM, etc.); and/or other images.

Any measurement can be associated with depth information (e.g., depth images, depth maps, DEMs, DSMs, etc.), terrain information, temporal information (e.g., a date or time when the image was acquired), other measurement, and/or any other information or data.

The measurements can be: remote measurements (e.g., aerial imagery, such as satellite imagery, balloon imagery, drone imagery, etc.), local or on-site measurements (e.g., sampled by a user, streetside measurements, etc.), and/or sampled at any other proximity to the property. The remote measurements can be measurements sampled more than a threshold distance away from the property, such as more than 100 ft, 500 ft, 1,000 ft, any range therein, and/or sampled any other distance away from the property.

The measurements can be: top-down measurements (e.g., nadir measurements, panoptic measurements, etc.), side measurements (e.g., elevation views, street measurements, etc.), angled and/or oblique measurements (e.g., at an angle to vertical, orthographic measurements, isometric views, etc.), and/or sampled from any other pose or angle relative to the property. The measurements can depict the property exterior, the property interior, and/or any other view of the property.

For example, when a property image is used, the property image can be an aerial image (e.g., satellite imagery, balloon imagery, drone imagery, etc.), imagery crowdsourced for a geographic region, an on-site image (e.g., street view image, aerial image captured within a predetermined distance to an object of interest, such as using a drone, etc.), and/or other imagery. The property image is preferably a top-down view of the region (e.g., nadir image, panoptic image, etc.), but can additionally or alternatively include an elevation view (e.g., street view imagery), an oblique view, and/or other views.

The property image can depict a geographic region larger than a predetermined area threshold (e.g., average parcel area, manually determined region, image-provider-determined region, etc.), a large-geographic-extent (e.g., multiple acres that can be assigned or unassigned to a parcel), encompass one or more parcels (e.g., depict a set of parcels), encompass a set of property components (e.g., depict a plurality of property components within the geographic region), encompass a region defined by hazard exposure (e.g., one or more previous wildfires, hailstorms, floods, earthquakes, and/or other hazard events), and/or any other suitable geographic region. The property image preferably depicts a built structure and/or a region surrounding a built structure, but can additionally or alternatively depict multiple structures, a site (e.g., campus), and/or any property or neighboring property components. The property image can additionally or alternatively include any other suitable characteristics.

The measurements can be received as part of a user request, retrieved from a database, determined using other data (e.g., segmented from an image, generated from a set of images, etc.), synthetically determined, and/or otherwise determined.

The measurements can be a full-frame measurement, a segment of the measurement (e.g., the segment depicting the property, such as that depicting the parcel; the segment depicting a geographic regions a predetermined distance away from the property; etc.), a merged measurement (e.g., a mosaic of multiple measurements), orthorectified, and/or otherwise processed. In a first example, the measurement is an image segmented from a larger image. The image can be segmented to depict: a parcel, a property component, an area around the property component, vegetation in a zone surrounding a property component, and/or any other image segment of interest. In a second example, the measurement is a 3D model of a property (e.g., of a structure, of terrain, etc.) generated from a set of images (e.g., 2D images) and/or depth information. In a third example, the measurement is synthetically determined using a set of non-synthetic measurements. In a specific example, measurements (e.g., imagery) are synthetically determined such that attribute values extracted from the synthetically determined measurements match a distribution (e.g., a distribution of attribute values extracted from a set of non-synthetic measurements, a predetermined distribution to match a population, a distribution selected to reduce model bias, etc.). However, the measurements can be otherwise obtained.

In examples, the measurements can be determined using the methods disclosed in U.S. application Ser. No. 16/833,313 filed 27 Mar. 2020 and/or U.S. application Ser. No. 17/336,134 filed 1 Jun. 2021, each of which is incorporated in its entirety by this reference. However, the measurements can be otherwise determined.

Determining attribute values for the property S300 can function to determine property-specific values of one or more components of the property of interest. S300 can be performed after S200, in response to a request (e.g., for a property), in batches for groups of properties, iteratively for each of a set of properties, at regular time intervals, when new data (e.g., measurements) for the property is received, during and/or after model training S500, during S400, and/or at any other suitable time.

Attributes can be components (e.g., property components), features (e.g., feature vectors, an attribute-value specification, etc.), masks, any parameter associated with a property component, higher-level summary data extracted from property components and/or features, variables, fields, predictors, and/or any other datum. Attributes of a property and/or property component can include: location (e.g., centroid location), boundary, distance (e.g., to another property component, to a geographic landmark, to wildland, setback distance, etc.), material, type, presence, count, density, geometry parameters (e.g., footprint and/or area, area ratios and/or percentages, complexity, number of facets, slope, height, etc.), condition (e.g., a condition rating), hazard context, geographic context, vegetation context (e.g., based on an area larger than the property), weather context, terrain context, historical construction information, ratios or comparisons therebetween, and/or any other parameter associated with one or more property components.

Examples of property attributes can include: structural attributes (e.g., for a primary structure, accessory structure, neighboring structure, etc.), location (e.g., parcel centroid, structure centroid, neighboring structure centroid, roof centroid, etc.), property type (e.g., single family, lease, vacant land, multifamily, duplex, etc.), pool and/or pool component parameters (e.g., area, enclosure, presence, pool structure type, count, etc.), deck material, car coverage (e.g., garage presence), solar panel parameters (e.g., presence, count, area, etc.), HVAC parameters (count, footprint, etc.), porch/patio/deck parameters (e.g., construction type, area, condition, material, etc.), fence parameters (e.g., spacing between fences), trampoline parameters (e.g., presence), pavement parameters (e.g., paved area, percent illuminated, etc.), foundation elevation, terrain parameters (e.g., parcel slope, surrounding terrain information, etc.), distance to highway, distance to coastline, distance to lake, distance to power line, distance to railway track, distance to river, proximity to wildland and/or any large fuel load, hazard potential (e.g., for wildfire, wind, fire, hail, flooding, etc.), zoning information (e.g., residential, commercial, and industrial zones; subzoning; etc.), other attributes that remain substantially static after built structure construction, temporary attributes (e.g., seasonal attributes, such as snow aggregation, etc.), and/or any other attribute.

Structural attributes can include: the structure footprint, structure density, count, structure class/type, proximity information and/or setback distance (e.g., relative to a primary structure, relative to another property component, etc.), building height, parcel area, number of bedrooms, number of bathrooms, number of stories, geometric attributes (e.g., area, area relative to structure area, geometry/shape, slope, complexity, number of facets, height, etc.), component parameters (e.g., material, roof extension, solar panel presence, solar panel area, etc.), framing parameters (e.g., material), flooring (e.g., floor type), historical construction information (e.g., year built, year updated/improved/expanded, etc.), area of living space, ratios or comparisons therebetween, and/or other attributes descriptive of the physical property construction.

Property attributes can be intrinsic (e.g., derived from the property itself) and/or extrinsic (e.g., determined based on information from another property or feature). Intrinsic attributes are preferably not condition related, but can alternatively be condition-related.

Condition-related attributes can include: roof condition (e.g., tarp presence, material degradation, rust, missing or peeling material, sealing, natural and/or unnatural discoloration, defects, loose organic matter, ponding, patching, streaking, etc.), exterior condition, accessory structure condition, yard debris and/or lot debris (e.g., presence, coverage, ratio of coverage, etc.), lawn condition, pool condition, driveway condition, tree parameters (e.g., overhang information, height, etc.), vegetation parameters (e.g., coverage, density, setback, location within one or more zones relative to the property), presence of vent coverings (e.g., ember-proof vent coverings), structure condition, occlusion (e.g., pool occlusion, roof occlusion, etc.), pavement condition (e.g., percent of paved area that is deteriorated), resource usage (e.g., energy usage, gas usage, etc.), and/or other parameters that are variable and/or controllable by a resident. Condition-related attributes can be a rating for a single structure, a minimum rating across multiple structures, a weighted rating across multiple structures, and/or any other individual or aggregate value. Condition-related attributes can additionally or alternatively be attributes subject to weather-related conditions; for example: average annual rainfall, presence of high-speed and/or dry seasonal winds (e.g., the Santa Ana winds), vegetation dryness and/or greenness index, regional hazard risks, and/or any other variable parameter.

In variants, attributes can include subattributes, wherein values are determined for each subattribute (alternatively, each subattribute can be treated as an attribute). For example, a given attribute can include one or more different subattributes corresponding to different zones relative to the property or property component. A zone can be a predetermined radius around the property or property component (e.g., the structure, the parcel, etc.) and/or any other region. Different attributes can have different zone distinctions (e.g., each attribute and/or subattribute has a zone classification). In a first illustrative example, for a vegetation coverage attribute, the zones may be defined as: zone 1=0-10 ft, zone 2=10-30 ft, and zone 3=30-100 ft. In a second illustrative example, for attributes related to the density and/or count of nearby structures, the zones may be defined as: zone 1=0-100 ft and zone 2=100-500 ft. In a third illustrative example, for a vegetation coverage attribute, the zones may be defined as: zone 1=0-5 ft, zone 2=5-30 ft, and zone 3=30-100 ft. However, any other number of zones and zone delineations may be implemented. Additionally or alternatively, different attributes can be defined for each component-zone combination (e.g., a first attribute can represent the vegetation coverage in zone 1, a second attribute can represent the vegetation coverage in zone 2, and a third attribute can represent the vegetation coverage in zone 3, etc.). However, the attributes can be otherwise defined.

In variants, one or more attributes can be associated with a mitigation classification, which can function to identify an attribute as mitigable (e.g., variable) or non-mitigable (e.g., invariable), to indicate the ease or difficulty of mitigation of an attribute for a property owner, to indicate the degree to which an attribute can be mitigated, to indicate whether an attribute can be mitigated by a community (e.g., multiple property owners), and/or to provide any other mitigation information associated with the attribute. The mitigation classification can be binary, multiclass, discrete, continuous, and/or any other classification type. In examples, mitigable attributes can include: vegetation or debris coverage (e.g., 0-10 ft from the property, within the parcel boundary, etc.), roof material, presence of ember-proof vent coverings, presence of wood decks, and/or any other attribute. In examples, non-mitigable attributes can include: structure density and/or count (e.g., for the property itself; including neighboring properties; etc.), property and/or structure size, vegetation coverage (e.g., 30-100 ft from property, outside the parcel boundary, etc.), parcel slope, and/or any other attribute. The mitigation classification can be the same or different for different hazards.

The mitigation classification can be determined: manually, automatically (e.g., based on the frequency of value change for the given attribute, based on the attribute value variability across different properties, etc.), predetermined, and/or otherwise determined. In a first variant, there is a predetermined association between attributes (e.g., subattributes) and mitigation classifications. In an example, for a given attribute, there is a predetermined relationship between subattribute zones and the mitigation classification for the respective subattribute zone. For example, attributes corresponding to zones near the property may be easier for the property owner to mitigate. In a first specific example, zone 1 vegetation coverage can be classified as mitigable, while zone 3 vegetation coverage is not. In a second specific example, zone 1 vegetation coverage is classified as more mitigable (e.g., a larger mitigation classification value) than zone 3 vegetation coverage. In a second variant, the mitigation classification can be determined based on property information (e.g., attribute values, measurements, property data, etc.). In a first example, the mitigation classification is determined based on property type (e.g., rural properties may have a larger mitigation radius). In a second example, the mitigation classification is determined based on a parcel boundary (e.g., vegetation coverage within the parcel boundary is classified as mitigable while vegetation coverage outside the parcel boundary is classified as non-mitigable). In a third example, the mitigation classification is determined based on property location (e.g., based on regulations associated with the property county regarding mitigations outside parcel boundaries). In a third variant, the mitigation classification is determined based on a community mitigation classification (e.g., mitigation by one or more property owners in addition to the owner of the property of interest and/or mitigation by a government body associated with the property location). In an illustrative example, vegetation coverage associated with a neighboring property (e.g., within the parcel boundaries of the neighboring property) is classified as mitigable, is classified as partially mitigable (e.g., a low mitigation classification value), and/or is associated with a separate community mitigation classification. In a fourth variant, the mitigation classification can be determined using a combination of the previous variants. For example, certain attributes can have a predetermined association with a mitigation classification, while other attributes have a variable mitigation classification based on property or community information. In an illustrative example, the roof material attribute is always classified as mitigable while the mitigation classification for vegetation coverage located greater than 30 ft is dependent on the parcel boundary.

However, attributes can be otherwise defined.

Attribute values can be discrete, continuous, binary, multiclass, and/or otherwise structured. The attribute values can be associated with time data (e.g., from the underlying measurement timestamp, value determination timestamp, etc.), a hazard event, a mitigation event (e.g., a real mitigation event, a hypothetical mitigation event, etc.), an uncertainty parameter, and/or any other suitable metadata.

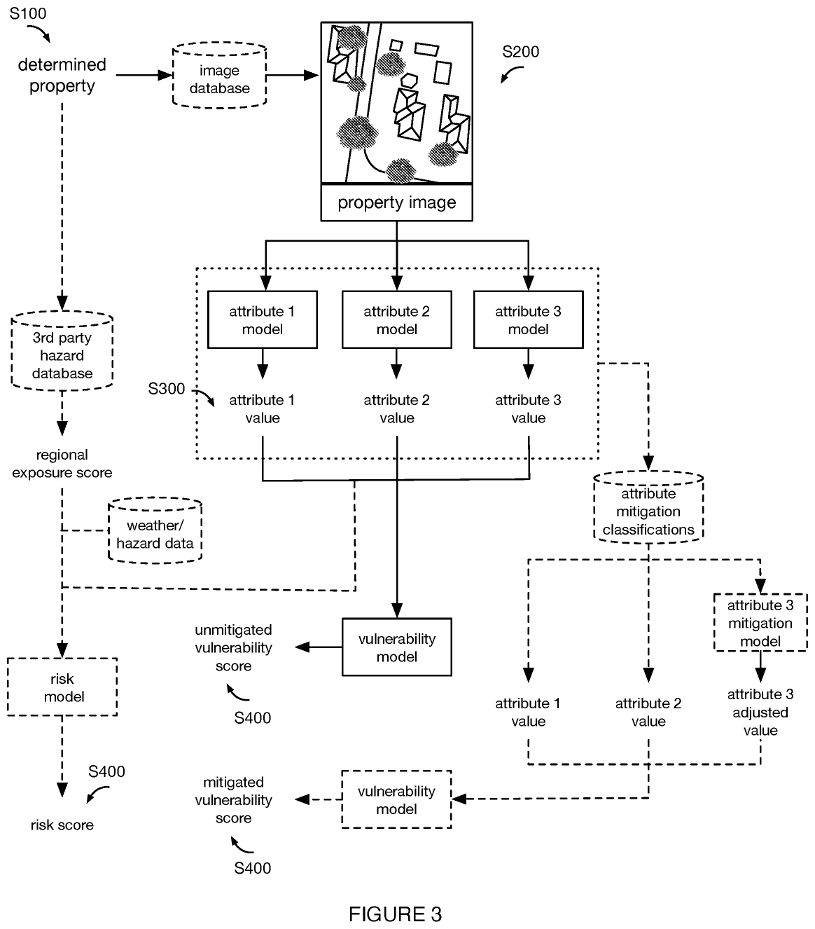

The attribute values can be determined by: extracting features from property measurements (e.g., wherein the attribute values are determined based on the extracted feature values), extracting attribute values directly from property measurements, retrieving values from a database or a third party source (e.g., third-party database, MLS database, city permitting database, historical weather and/or hazard database, tax assessor database, etc.), using a predetermined value (e.g., assuming a given mitigation action has been performed as described in S400), calculating and/or adjusting a value (e.g., from an extracted value and a scaling factor; adjusting a previously determined attribute value as described in S400; etc.), and/or otherwise determined; an example is shown in FIG. 3. The attribute values can be: based on a single property, based on a larger geographic context (e.g., based on a region larger than the property parcel size), and/or otherwise determined. Attribute values can be determined using an attribute value model that can include: CV/ML attribute extraction, any neural network and/or cascade of neural networks, one or more neural networks per attribute, key point extraction, SIFT, calculation, heuristics (e.g., inferring the number of stories of a property based on the height of a property), classification models (e.g., binary classifiers, multiclass classifiers, semantic segmentation models, instance-based segmentation models, etc.), regression models, object detectors, any computer vision and/or machine learning method, and/or any other technique. Different attribute values can be determined using different methods, but can alternatively be determined in the same manner. In an example, determining an attribute value can include: determining a segmentation mask based on a measurement; using the segmentation mask, identifying pixels of the measurement corresponding to the attribute (e.g., identifying pixels corresponding to a property component associated with the attribute); determining a measurement segment based on the identified pixels; and extracting an attribute value for the attribute based on the measurement segment (e.g., based on pixels in the measurement segment; based on features extracted from the measurement segment; etc.). In a specific example, the segmentation mask can be determined using an image segmentation model. Examples of image segmentation models include a semantic segmentation model (e.g., wherein the segmentation mask includes a semantic segmentation mask), an instance-based segmentation model, and/or any other computer vision model. In another example, determining an attribute value can include: extracting features from a measurement (e.g., using a feature extractor); identifying a property component depicted in the measurement based on the extracted features (e.g., using an object detection model); and determining an attribute value for an attribute associated with the identified property component based on the measurement. In a specific example, identifying the property component can include identifying pixels of the measurement corresponding to the property component, wherein the attribute value can be determined based on the identified pixels corresponding to the property component.

In a first illustrative example, vegetation coverage in zone 1 is determined by identifying a primary structure in a property image and determining a percentage of the area within 10 feet of the primary structure that includes vegetation. In a second illustrative example, an attribute value for the number of bedrooms in a structure is retrieved from a property database. In a third illustrative example, the structure footprint is extracted from a first measurement (e.g., image), the parcel footprint is extracted from a second measurement (e.g., parcel boundary database, a second image, etc.), and an attribute value corresponding to the ratio therebetween is then calculated. In a fourth illustrative example, a roof complexity attribute value can be determined by identifying roof facets from property image(s), counting the number of roof facets, determining the geometry of roof facets, fitting 3D planes to roof segments, and/or any other feature and/or attribute extraction method.

An uncertainty parameter associated with an attribute value can include variance values, a confidence score, and/or any other uncertainty metric. In a first illustrative example, the attribute value model classifies the roof material for a structure as: shingle with 90% confidence, tile with 7% confidence, metal with 2% confidence, and other with 1% confidence. In a second illustrative example, 10% of the roof is obscured (e.g., by a tree), which can result in a 90% confidence interval for the roof geometry attribute value. In a third illustrative example, the vegetation coverage attribute value is 70%±10%.

In examples, the attribute values can be determined using the methods disclosed in U.S. application Ser. No. 16/833,313 filed 27 Mar. 2020 and/or U.S. application Ser. No. 17/336,134 filed 1 Jun. 2021, each of which is incorporated in its entirety by this reference. However, the attribute values can be otherwise determined.

S300 can optionally include selecting a set of attributes from a set of candidate attributes S340. Selecting a set of attributes can function to select a subset of attributes (e.g., from all available attributes, from attributes corresponding to a hazard and/or region, attributes retrieved from a database, etc.) that are predictive of a metric (e.g., claim data metric, other hazard metric, etc.). This can function to: reduce computational time and/or load (e.g., by reducing the number of attributes that need to be extracted and/or processed), increase evaluation metric prediction accuracy (e.g., by reducing or eliminating confounding attributes), and/or be otherwise used. S340 can be performed during S400, prior to S500, during S500, after S500, and/or at any other time. The selected attributes can be the same or different for different properties, regions, hazards, evaluation metrics, environmental evaluation models, property types, seasons, and/or other populations.

The set of attributes (e.g., for a given environmental evaluation model) can be selected: manually, automatically, randomly, recursively, using an attribute selection model, using lift analysis (e.g., based on an attribute's lift), using any explainability and/or interpretability method (e.g., as described in S600), based on an attribute's correlation with a given metric (e.g., claim frequency, loss severity, etc.), using predictor variable analysis, through evaluation metric validation, during model training (e.g., attributes with weights above a threshold value are selected), using a deep learning model, based on the mitigation and/or zone classification, and/or via any other selection method or combination of methods.

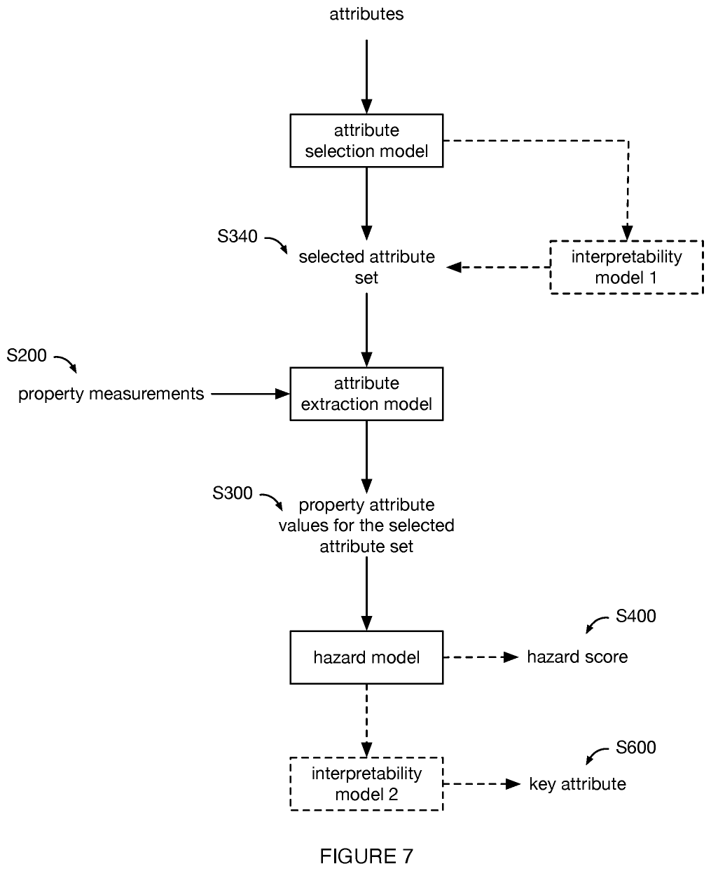

In a first variant, the set of attributes is selected such that an evaluation metric determined based on the set of attributes is indicative of a key metric. The metric can be a training target (e.g., the same training target used in S500, the key metric in S400, a different training target, etc.), and/or any other metric. For example, the key metric can be: the probability of a claim being filed for the property (e.g., claim occurrence) (e.g., within a given timeframe), claim acceptance probability, claim rejection probability, an expected loss amount, a hazard exposure probability, a claim and/or damage occurrence, a combination of the above (e.g., claim occurrence and acceptance probability) and/or any other metric. The claims can be: insurance claims, aid claims (e.g., FEMA claims), and/or any other suitable claim. In an example, a statistical analysis of training data can be used to select attributes that have a nonzero statistical relationship (e.g., correlation, interaction effect, etc.) with the key metric (e.g., positive or negative correlation with claim filing occurrence). In a second variant, the set of attributes is selected using a combination of an attribute selection model and a supplemental validation method. For example, the supplemental validation method can be any explainability and/or interpretability method (e.g., described in S600), wherein the selection method determines the effect an attribute has on the evaluation metric. When this effect is incorrect or introduces biases (e.g., based on a manual determination using domain knowledge, based on a comparison with a validated environmental evaluation model, etc.), the attribute selection and/or the environmental evaluation model can be adjusted. In a third variant, the set of attributes can be selected to include all available attributes. An example is shown in FIG. 7. However, the attribute set can be otherwise selected.

However, the attributes and/or attribute values can be otherwise determined.

Determining an evaluation metric for the property S400 can function to determine a score for the property associated with a vulnerability and/or risk to one or more hazards, to determine the potential for mitigation of the vulnerability and/or risk, to determine a metric associated with a claim for the property (e.g., a hypothetical or real claim), and/or to determine any other metric for the property associated with a hazard. Determining an evaluation metric can be performed once for the determined property, multiple times (e.g., for multiple hazards, for multiple score types of a given hazard, the same evaluation metric using different attribute sets, etc.), iteratively for each property in a group (e.g., within a predetermined region), after S300, during S500, and/or at any other suitable time. Each evaluation metric is preferably specific to a given property, but can alternatively be shared across multiple properties.

The evaluation metric can be stored in association with the property (e.g., in a database); returned via a user device (e.g., user interface), API, GUI, or other endpoint; used downstream to select one or more properties; used downstream to select one or more mitigation measures; or otherwise managed.

The evaluation metric (e.g., hazard score) can be: a vulnerability score (e.g., an unmitigated vulnerability score and/or a mitigated vulnerability score), a regional exposure score, a risk score, a combination of scores, and/or any other metric for one or more properties. The evaluation metric can be an unmitigated evaluation metric (e.g., current evaluation metric; determined based on unadjusted attribute values), a mitigated evaluation metric (e.g., predicted evaluation metric; determined based on adjusted attribute values), and/or otherwise configured. Any score can be associated with (e.g., representative of, a probability of, an expected value of, an estimated value of, etc.) a key metric such as: loss and/or damage severity (e.g., based on a submitted claim value, monetary damage cost, detected property damage, detected property repair, etc.), claim occurrence (e.g., whether or not a claim was or will be submitted for a property within a given time period), claim frequency, claim rejection and/or claim adjustment, damage occurrence, a change in property value after hazard event, hazard exposure, another evaluation metric, and/or any other target (e.g., a training target as described in S500). Any score can be associated with a timeframe (e.g., the probability of hazard exposure within the timeframe, the probability of damage occurring within the timeframe, the probability of filing a claim within the timeframe, etc.) and/or unassociated with a timeframe.

Each evaluation metric is preferably determined using an environmental evaluation model (e.g., a model trained in S500), but can alternatively be retrieved (e.g., from a third-party hazard risk database) and/or otherwise determined. The environmental evaluation model (e.g., hazard model) can be or use: regression, classification, neural networks (e.g., CNNs, DNNs, etc.), rules, heuristics, equations (e.g., weighted equations with a predetermined weight for each input attribute, etc.), selection (e.g., from a library), instance-based methods (e.g., nearest neighbor), regularization methods (e.g., ridge regression), decision trees (e.g., random forest, gradient boosted, etc.), Bayesian methods (e.g., Naïve Bayes, Markov), kernel methods, probability, deterministics, genetic programs, support vectors, or any other suitable method. The environmental evaluation model can be the same or different for each evaluation metric, hazard, region, property type, time period, and/or any other parameter.

The environmental evaluation model inputs (e.g., ingested by the model, influencing the model, etc.) can include: attribute values, property measurements, other evaluation metrics (e.g., calculated using an environmental evaluation model, retrieved from a third-party hazard database, etc.), property location, data from a third-party database (e.g., property data, hazard exposure risk data, claim/loss data, policy data, weather and/or hazard data, fire station locations, insurer database, etc.), dates (e.g., a timeframe under consideration, dates of a hypothetical or real claim filing, dates of previous hazard events, etc.), and/or any other input. Weather data (and/or hazard data and/or other weather-related data) can include: dates of prior hazard events, the severity of prior hazard events (e.g., hail size, wind speeds, wildfire boundary, fire damage severity, flood magnitude, etc.), locations of prior hazard events (e.g., relative to the property location, hazard perimeter, etc.), regional hazard occurrence and/or severity information (e.g., frequency of hazard events, average severity of hazard events, etc.), general weather data (e.g., average wind speeds, temperatures, etc.), evaluation metrics (e.g., third-party regional exposure scores), and/or any other data associated with a location. In a first specific example, the environmental evaluation model (e.g., a risk model) ingests attribute values for the property and a retrieved evaluation metric associated with the property location. In a second specific example, the environmental evaluation model (e.g., a vulnerability model) ingests attribute values for the property (e.g., only; without ingesting weather data, hazard data, and/or other data associated with the regional property location). In a third specific example, the environmental evaluation model (e.g., a damage model, a claim rejection model, etc.) ingests attribute values for the property and weather data. In a fourth specific example, the environmental evaluation model (e.g., a damage model, a claim rejection model, etc.) ingests a determined evaluation metric (e.g., vulnerability score) and weather data. In a fifth specific example, the environmental evaluation model (e.g., any one of those described above or another model) ingests property measurements in addition to or instead of attribute values. Optionally, weights for one or more model inputs can be determined during model training S500, based on a decision tree, based on any neural network, based on a set of heuristics, manually, and/or otherwise determined.

The evaluation metric can be a label, a probability, a metric, a monetary value, and/or any parameter. The score can be binary, continuous, discrete, binned, and/or otherwise configured. The evaluation metric can optionally include an uncertainty parameter (e.g., variance, confidence score, etc.) associated with: the environmental evaluation model, a training data set (e.g., based on recency), attribute value uncertainty parameters, and/or any other parameter. The evaluation metric can be—or be calculated from—the environmental evaluation model output.

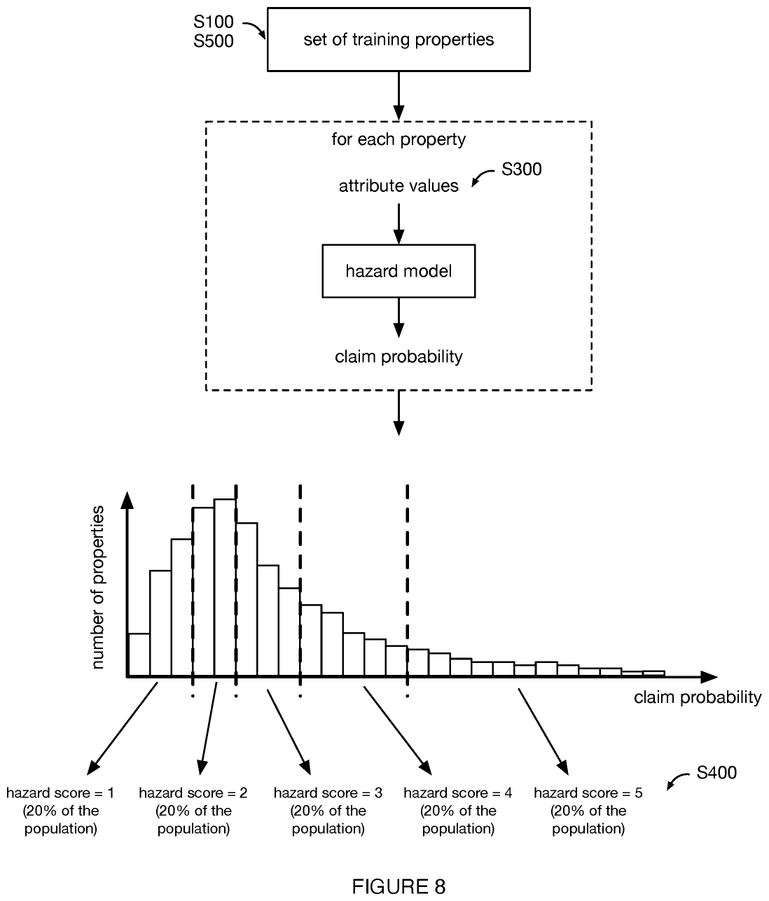

In variants, the environmental evaluation model outputs a continuous value (e.g., a claim filing and/or rejection probability, a loss amount, a hazard exposure likelihood, etc.), which can be mapped to a discrete bin (e.g., 1 to 5, 1 to 10, etc.), wherein the discrete bin value can be treated as the evaluation metric. Alternatively, the environmental evaluation model can predict the bin (e.g., directly), predict the probability of being in a bin, predict a position between bins, and/or predict any other score. In an illustrative example, the highest risk properties (e.g., highest probability of submitting a claim) can be assigned an evaluation metric bin of 1 and the lowest risk properties an evaluation metric bin of 5 (or vice versa), wherein the predicted probability for a property is assigned to a bin value post-prediction. In another example, the environmental evaluation model can predict a bin value for a property (e.g., 3.6). The binning can be uniformly distributed, nonuniformly distributed, normally distributed, distributed based on (e.g., matching) a distribution or percentage of a training data population (e.g., the set of training properties in S500), distributed based on another score's distribution (e.g., a third-party hazard risk score distribution), and/or have any other distribution (e.g., have a predetermined distribution across the training property set). Each binned evaluation metric can be associated with different or matching: binning logic, binning distributions (e.g., to enable improved score combinations). An example is shown in FIG. 8.

In a first example, a continuous environmental evaluation model output (e.g., a probability decimal from 0 to 1) is mapped to a bin such that the bin values for a set of properties have a predetermined distribution (e.g., uniform distribution, normal distribution, etc.). The set of properties can be the set of training properties (S500), a set of test properties, and/or any other set of properties. In a specific example, the evaluation metrics for each property are binned such that each bin corresponds to approximately a predetermined proportion (e.g., 10%, 20%, 25%, 50%, etc.) of the population of properties. In a second example, the continuous environmental evaluation model output is mapped to a bin such that the bin values for a set of properties have a distribution matching that of third-party evaluation metrics (e.g., the distributions match for the same set of properties). In a third example, the binning logic is predetermined, and binning is directly based on the environmental evaluation model output. In a first specific example, a property is assigned an evaluation metric of 1 when the property has a probability of filing a claim above 5%; a score of 2 when the probability is between 4% and 5%, a score of 3 when the probability is between 2% and 4%, a score of 4 when the probability is between 0.5% and 2%, and a score of 5 when the probability is below 0.5%. In a second specific example, the bins are assigned based on a claim severity value (e.g., an evaluation metric of 1 corresponds to a loss greater than $10,000, an evaluation metric of 2 corresponds to a loss of greater than $50,000, etc.). Additionally or alternatively, a environmental evaluation model can be trained to directly output the discrete bin value (S500).

In a first variant, the evaluation metric is a vulnerability score. The vulnerability score is preferably associated with or represents a key metric (e.g., probability of the property filing a claim within a timeframe) given the exposure of the property to a (hypothetical) hazard, but can alternatively be associated with or represent a key metric not conditional on hazard exposure. The vulnerability score (and inputs ingested by a vulnerability model used to determine the vulnerability score) is preferably independent of the exposure risk of the property to that hazard (e.g., the regional exposure score) and/or any regional data (e.g., regional hazard risk, weather data, hazard data, location data, etc.). Alternatively, the vulnerability can be dependent on the exposure risk (e.g., weighted and/or otherwise adjusted based on the regional exposure score) and/or any regional data. In an illustrative example, the vulnerability score is representative of the vulnerability of a property to a hazard (e.g., probability of claim occurrence, severity of damage, etc.) assuming exposure to the hazard, wherein the vulnerability model (e.g., trained in S500) ingests property attribute values (e.g., intrinsic property attribute values, independent from regional location) and does not ingest weather and/or hazard data.

The vulnerability score can be predicted based on property measurements using a vulnerability model. In a first embodiment, the vulnerability score is directly predicted based on property measurements by the vulnerability model. In a second embodiment, the vulnerability score is predicted based on property attribute values (e.g., S300) extracted from the property measurements (e.g., in S200) by the vulnerability model. However, the vulnerability score can be otherwise predicted.

In a second variant, the evaluation metric is a regional exposure score (e.g., a regional hazard risk metric). The regional exposure score can be associated with or represent the probability of a hazard occurring at or near the property (e.g., based on historical weather and/or hazard data and the property location, retrieved from a third-party regional hazard database, etc.). The regional exposure score can be determined using a regional model (e.g., based on regional hazard history, predictions, etc.), retrieved from a database, and/or otherwise determined. In a first example, the regional exposure score is directly retrieved from a third-party database. In a second example, the regional exposure score is determined using historical weather and/or hazard data for the property location. In a third example, the regional exposure score is calculated based on attribute values for the property and a retrieved regional exposure score (e.g., for a flooding hazard, the local terrain at or near the property can be used to adjust the retrieved regional exposure score).

In a third variant, the evaluation metric is a risk score (e.g., an overall risk score). The risk score can be associated with or represent the overall likelihood of a claim loss being filed, predicted claim loss frequency, expected loss severity, and/or any other key metric. This risk score is preferably dependent on the likelihood of hazard exposure (e.g., in contrast to the vulnerability score), but can alternatively be independent of and/or conditional on the hazard exposure. The risk score can be predicted based on: property measurements (e.g., directly), property attribute values extracted from property measurements, historical weather and/or hazard data, another evaluation metric (e.g., regional exposure score), and/or any other suitable information.

In examples, the risk score can be predicted based on another evaluation metric (e.g., the regional exposure score), based on a combination of evaluation metrics, determined independently from other scores, determined from property measurements, and/or determined based on any other set of inputs. In a first example, the risk score can be determined using a risk model that ingests property attribute values and the regional exposure score. In a second example, the risk score can be determined using a risk model that ingests: property attribute values and historical weather and/or hazard data for the property location. In a third example, the risk score can be a combination of the vulnerability score, the regional exposure score, another risk score, and/or other evaluation metrics. This combination can be a mathematical operation (e.g., multiplying a regional risk score by the vulnerability score, summing scores, a ratio of scores, etc.), any algorithm, and/or any other model ingesting the scores. In a fourth example, the risk score can be determined using a risk model that ingests: property measurements (e.g., pre-hazard-event measurements and/or post-hazard event measurements), regional exposure score (e.g., for the region that the property is located within), optionally property attribute values, optionally location data, and/or any other information. However, the risk score can be otherwise predicted.

In a fourth variant, the evaluation metric is a mitigated evaluation metric (e.g., a mitigated vulnerability score) associated with the effect of one or more mitigation measures (e.g., the predicted evaluation metric if one or more mitigation measures were implemented). The mitigation measure can be hypothetical or realized.

Mitigation measures (e.g., mitigation actions) can be represented as an adjustment to one or more attribute values (e.g., mitigable attributes, where an adjustment is associated with each mitigable attribute). The adjusted attribute value (e.g., the predicted attribute value) can represent what the attribute value would be after a hypothetical mitigation measure were implemented. Attribute values can be adjusted for all or a portion of mitigable attributes (e.g., all mitigable attributes from the set of attributes selected in S340, all mitigable attributes associated with a given mitigation measure, etc.). For example, values (determined in S300) for a set of mitigable attributes can be adjusted, wherein each mitigable attribute is associated with one or more mitigation measures and/or degrees thereof. The mitigation-adjusted values can be: manually specified, automatically determined (e.g., learned from historical mitigation and associated evaluation metric changes, calculated, predetermined, etc.), and/or otherwise determined.

In a first variant, the attribute values are adjusted using a predetermined association between mitigation measures (and/or degrees thereof) and attribute values. In a first example, the mitigation measure of removing all flammable debris from zone 1 can result in an attribute value for flammable debris dropping to 0 (or any value). In a second example, the mitigation measure of partially removing flammable debris from zone 1 can result in an attribute value for flammable debris dropping to 1 (or any value). In a third example, the mitigation measure of changing the roof material to metal can result in an attribute value for the roof material dropping to 0 (or any value), while changing the roof material to tile (e.g., from a shingle material) can result in the attribute value dropping to 1 (or any value). In a fourth example, the mitigation measure of changing the roof material from shingle to tile can result in an attribute value for the roof material changing from a ‘shingle’ classification to a ‘tile’ classification.

In a second variant, the attribute values are adjusted using a predetermined association between mitigation measures (and/or degrees thereof) and attribute value corrections (e.g., halving; scaling linearly, logarithmically, etc.). In a first example, removing vegetation coverage from zone 1 can be associated with halving the previously determined vegetation coverage zone 1 attribute value (e.g., from 6 to 3). In a second example, an overall vegetation coverage attribute value is determined by aggregating attribute values for vegetation coverage in zone 1, zone 2, and zone 3. Removing vegetation coverage from zone 1 can be associated with halving the previously determined vegetation coverage zone 1 attribute value, wherein the overall vegetation coverage attribute value is then recalculated using the adjusted zone 1 attribute value to determine a mitigation-adjusted attribute value.

In a third variant, the attribute values are adjusted using a model, wherein the model adjusts a mitigable attribute value based on: property information (e.g., attribute values, measurements, property data, etc.), mitigation measures, mitigation measure degrees (e.g., partial mitigation, full mitigation, etc.), and/or any other suitable information. In a first example, a vegetation coverage attribute value can be adjusted based on parcel boundary information. In an illustrative example, if 30% of vegetation coverage less than 100 ft (or any threshold) from the property is within the parcel boundary, the vegetation coverage attribute value can be reduced by 30%. In a second example, an adjusted roof material attribute value can be calculated based on roof geometry, pre-mitigation roof material (e.g., shingle), post-mitigation roof material (e.g., metal) and/or any other attribute values.

In a fourth variant, the attribute values are adjusted by re-determining the attribute value (e.g., re-extracting the attribute value) from synthetic measurements. The synthetic measurements can be determined based on the original measurements that were used to determine the original (un-adjusted) attribute values. For example, synthetic measurements can be original measurements (e.g., property images) that are altered such that segments of the original measurements corresponding to the mitigable attribute reflect the implementation of a mitigation measure. In an illustrative example, the image of a roof in a property image can be altered to reflect a change in roof material, wherein the altered image is used to extract the mitigation-adjusted attribute value.

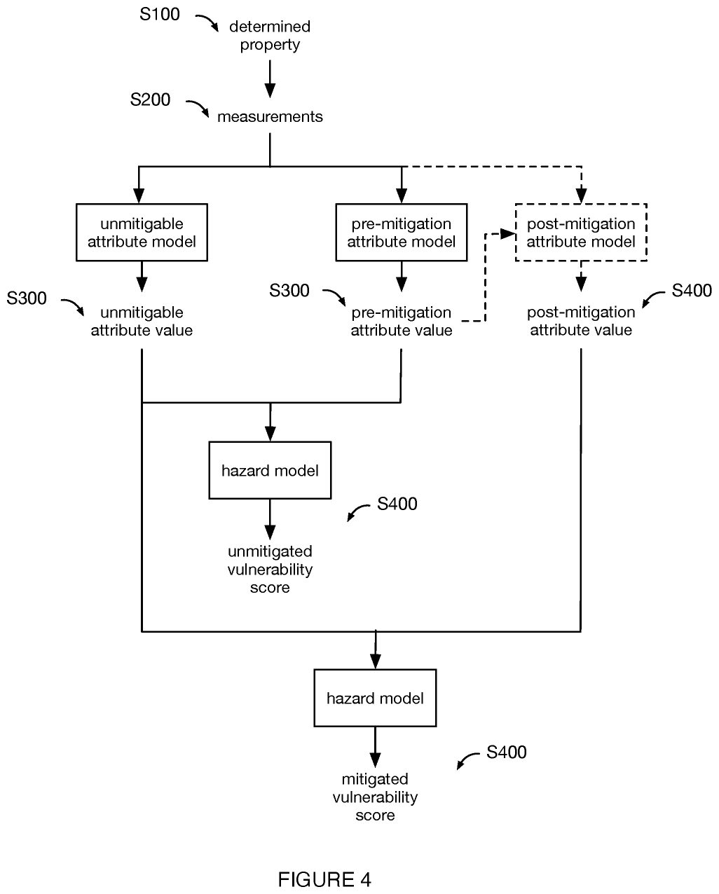

In a first example, the mitigated evaluation metric can be an evaluation metric re-calculated using the same attribute set as the corresponding unmitigated evaluation metric (and the same environmental evaluation model), wherein only values for the mitigable attributes (e.g., variable attributes) are adjusted for the mitigated evaluation metric calculation (attribute values for non-mitigable attributes remain unadjusted). In an illustrative example, the mitigated evaluation metric is a re-calculated vulnerability score with the zone 1 vegetation coverage attribute value set to o and the zone 2 vegetation coverage attribute value halved. In a second example, a mitigated evaluation metric and a corresponding unmitigated evaluation metric can have different attribute sets (e.g., selected using different training datasets; individually adjusted using explainability, interpretability, and/or manual methods; etc.). In a third example, the mitigated and unmitigated evaluation metrics can be calculated using different environmental evaluation models (e.g., trained in S500 with different training datasets; the mitigated environmental evaluation model is an adjusted unmitigated environmental evaluation model; etc.). An example is shown in FIG. 4. However, the mitigated evaluation metric (e.g., predicted evaluation metric) can be otherwise predicted.

In a fifth variant, the evaluation metric is a damage score (e.g., property damage score, claim loss score, etc.). The damage score can be associated with or represent the probability of pre-existing damage to a property, the probability of damage to a property given one or more (hypothetical or real) hazard events, the expected severity of damage to a property and/or claim loss severity (given one or more previous or hypothetical hazard events), and/or any other key metric. The damage score can be predicted based on: property measurements (e.g., directly), property attribute values extracted from property measurements, historical weather and/or hazard data, another evaluation metric (e.g., regional exposure score), and/or any other suitable information.

In a first example, the damage score is determined using a damage model that ingests property attribute values and historical hazard and/or weather data (e.g., dates and severity of hazard events within a given timeframe). In a second example, the damage score is determined using a damage model that ingests property attribute values and weather and/or hazard data for one or more specific hazard events (e.g., the most recent hazard event(s), a hazard event associated with a filed claim, etc.). In a third example, the damage score is determined based on whether a hazard event has historically occurred in the property's geographic region (e.g., after the last property repair, remodel, or drastic appearance change) and the property's vulnerability score (e.g., using a trained neural network, using an equation, using a statistical model, etc.). In a fourth example, the damage score is determined based on changes in the property detected between measurements sampled before and after a hazard event. In variants, the damage model can be trained to predict the damage score for a given property, given the pre- and/or post-hazard measurement. However, the damage score can be otherwise predicted.

In a sixth variant, the evaluation metric is a claim rejection score. The claim rejection score can be associated with or represent the probability of a filed claim being rejected by the insurer or payor (or the probability of the filed claim not being rejected by the insurer), the probability of a filed claim being adjusted, the amount and/or valence of claim adjustment, a binary assessment of whether to deploy a claim adjuster, and/or any other key metric. The claim rejection score can be predicted based on: property measurements (e.g., directly), property attribute values extracted from property measurements, historical weather and/or hazard data, another evaluation metric (e.g., regional exposure score), and/or any other suitable information.

For example, the claim rejection score can be determined using a claim rejection model that ingests property attribute values and weather and/or hazard data for one or more specific hazard events (e.g., the one or more most recent hazard events, a hazard event associated with a filed claim, etc.). In another example, the claim rejection score can be determined based on the uncertainty of another evaluation metric's prediction. In an illustrative example, when the uncertainty of a property's risk score and/or vulnerability score is high (e.g., above a threshold value), the claim rejection score can be high (e.g., indicate that a claim adjuster should be deployed). However, the claim rejection score can be otherwise predicted.

However, the evaluation metric can be otherwise determined.

The method can optionally include training one or more environmental evaluation models S500. S500 can function to train environmental evaluation models to output an evaluation metric correlated with a training target. S500 can be performed for a set of training properties (e.g., wherein the property of interest is within the set of training properties or not within the set of training properties), for a given claim dataset, iteratively performed as new data (e.g., claim data, measurements, property lists, historical weather and/or hazard data, etc.) is received, before S400, and/or at any other time.

The method can train one or more environmental evaluation models. Each environmental evaluation model can be specific to a single hazard class (e.g., flood, hail, snow, etc.) or predict scores for multiple hazard classes. Each environmental evaluation model can be specific to a given geographic region (e.g., St Paul, San Francisco, Midwest, etc.), or be generic to multiple geographic regions. Each environmental evaluation model can be specific to a given hazard risk profile (e.g., a regional exposure score range, a regional hazard risk range, etc.), or be generic across hazard risk profiles. Each environmental evaluation model can be specific to a score type (e.g., risk score, vulnerability score, etc.), or predict different score types. However, the one or more environmental evaluation models can be otherwise related or unrelated.

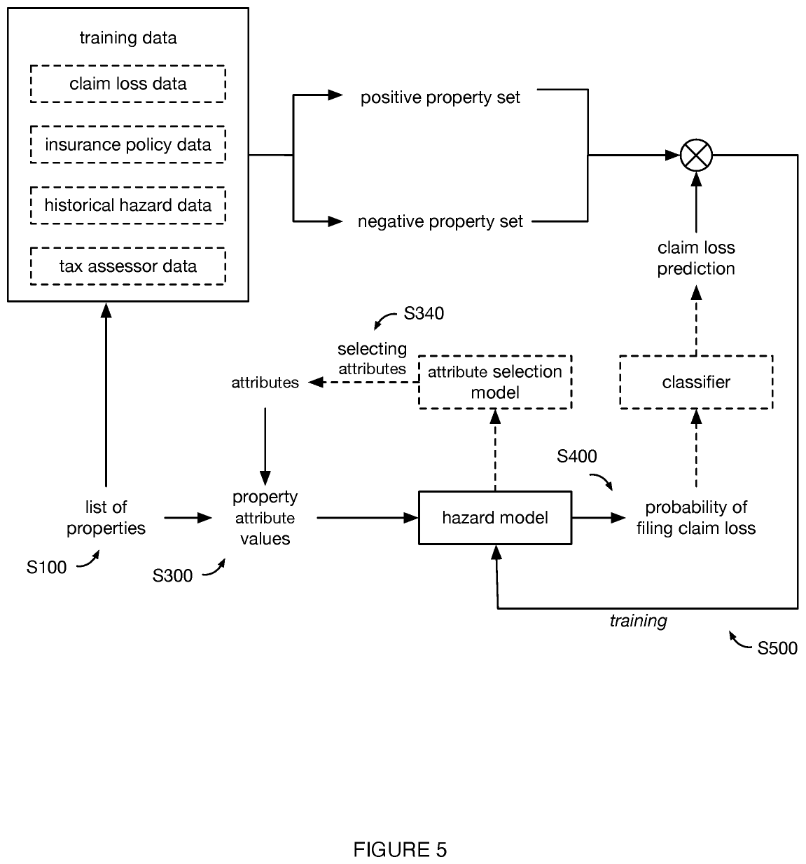

The environmental evaluation model can be trained using a training data set, wherein the training data can include: a set of training properties, training inputs (associated with each training property), and training targets (associated with each training property). The environmental evaluation model can ingest the training inputs for each training property, wherein the resulting environmental evaluation model output and/or post-processed model output (e.g., a classification based on the output) can be compared to the training target to drive model training. An example is shown in FIG. 5. Any portion of the training data can be provided by a third party; alternatively, none of the training data is provided by a third party.

The set of training properties can be selected based on: property location (e.g., associated with a hazard exposure and/or lack of exposure), weather and/or hazard data (e.g., hazard perimeter data such as wildfire perimeter, hail-effected perimeter, flood perimeter, etc.), historical homeowners' policies, any property outcome data (e.g., described below). Examples of sets of training properties include: properties within a given region (e.g., hazard perimeter, geographic region, etc.), properties exposed to a hazard (e.g., within a given time frame), all properties regardless of hazard exposure (e.g., all properties within a set of regions, of a property type, associated with a given insurance policy, etc.), properties that have experienced damage, properties that have filed a claim, properties that have received a response from an insurance company regarding a filed claim, and/or any other property group. Preferably, the set of training data includes properties from multiple geographic regions (e.g., multiple regions across a country or multiple countries, wherein the regions can share environmental commonalities or not share environmental commonalities), but alternatively the set of training data includes properties from a single geographic region (e.g., a state, a region within a state, etc.).

In a first example, a vulnerability model (and/or a damage model) is trained using a set of training properties that includes only properties previously exposed to a given hazard (e.g., within a given time frame). In a specific example, the hazard is a wildfire and only properties inside or within a predetermined geographic range of one or more wildfires (e.g., within 1 mi, 3 mi, 5 mi, 10 mi, etc.) are included. In a second example, a risk model is trained using a set of training properties that includes all properties regardless of hazard exposure (e.g., all properties within a set of regions, of a property type, associated with a given insurance policy, etc.). In a third example, a claim rejection model is trained using a set of training properties that includes only properties that have filed a claim and/or that have received a response from an insurance company regarding the filed claim. However, any other set of training properties can be used.

The training inputs for each training property can include and/or be based on: property measurements (e.g., acquired before a hazard event, after a hazard event, and/or unrelated to a hazard event), property attribute values, a property location, an evaluation metric, data from a third-party database (e.g., property data, hazard risk data, claim/loss data, policy data, weather data, hazard data, fire station locations, tax assessor database, insurer database, etc.), dates, and/or any other input (e.g., as described in S400).

The training target for each training property can be based on property outcome data, including: claim data, damage and/or loss data, insurance policies, tax assessor data, weather and/or hazard data, property measurements, evaluation metrics, and/or any other property outcome data. The training target can be any key metric, such as: loss and/or damage severity (e.g., based on a submitted claim value, monetary damage cost, detected property damage, detected property repair, etc.), claim occurrence (e.g., whether or not a claim was or will be submitted for a property within a given time period), claim frequency, claim rejection and/or claim adjustment, damage occurrence, a change in property value after hazard event, hazard exposure, another evaluation metric, and/or any other metric. The training target can be: discrete, continuous, binary, multiclass, and/or otherwise configured. The training target can have the same or different form as: the model output, the evaluation metric, and/or any other value.

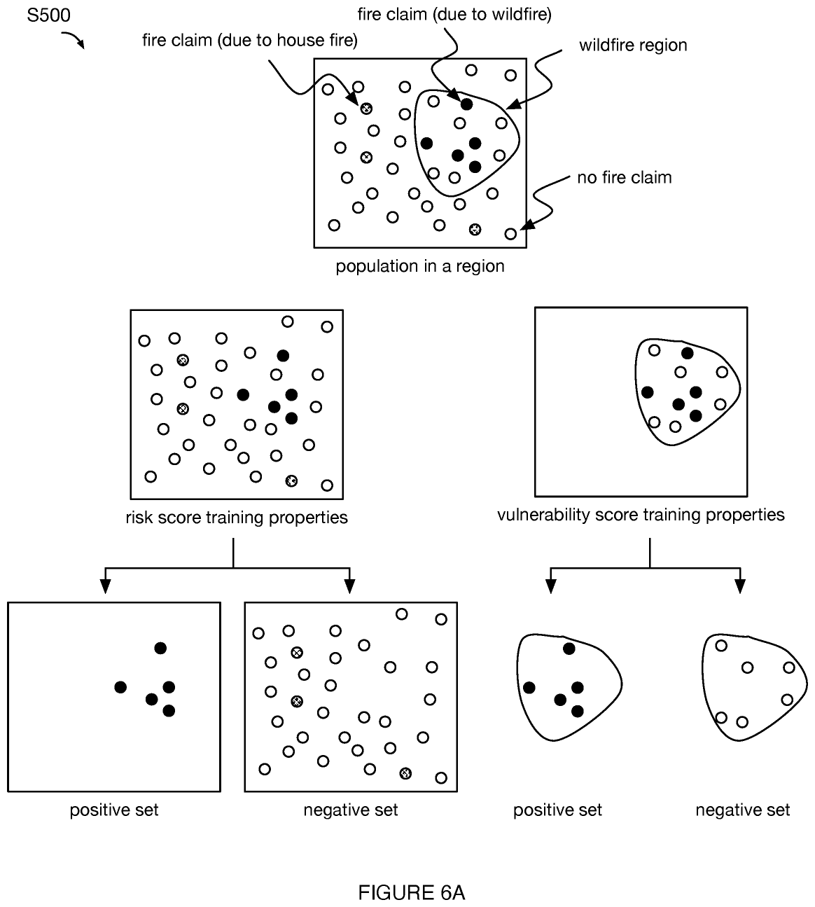

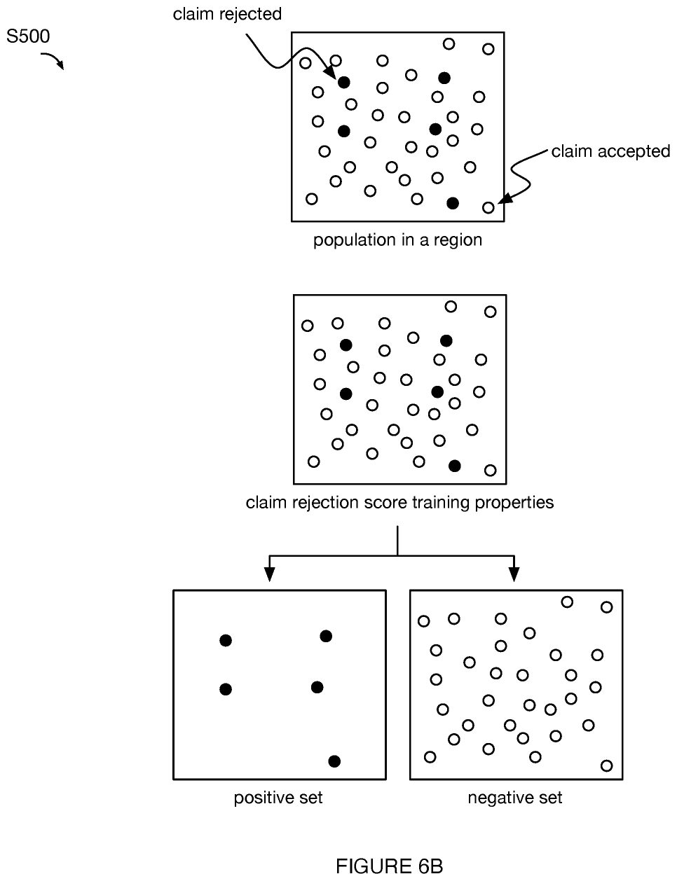

In a first variant, the training target is claim data within a historical timeframe. In a first embodiment, the training data is segmented into positive and negative sets, wherein the positive or negative classification for each property is the binary training target. In a first example of the first embodiment, for an environmental evaluation model (e.g., vulnerability model, risk model, etc.) with binary claim occurrence as the training target, properties in the set of training properties with claims submitted for fire damage (e.g., within the historical timeframe) are in the positive dataset. In this example, house fire claims can be classified as false positives and/or only claims for wildfire damage are considered true positives. All other training properties in the set (e.g., all other properties exposed to the hazard, all other properties regardless of exposure, etc.) are in the negative dataset; an example is shown is FIG. 6A. In a second example of the first embodiment, for an environmental evaluation model (e.g., claim rejection model) with binary claim rejection as the training target, properties in the set of training properties with rejected claims are in the positive dataset and all other properties (e.g., all other properties with filed claims) are in the negative dataset; an example is shown is FIG. 6B. In a second embodiment, the training target is non-binary claim data. In examples, the environmental evaluation model is trained using loss amount, claim frequency, claim type, and/or any other non-binary training target.

In a second variant, the training target is determined based on a set of property measurements acquired prior to an event and a set of property measurements acquired after the event (e.g., based on a detected property change determined using the sets of property measurements). In a first example, the event is a hazard event, and the training target (e.g., for a damage model) is a presence/absence of detected property damage and/or change. In a second example, the event is a mitigation measure implementation, and the training target is a presence/absence of the mitigation measure.

In a third variant, the training target is a previously determined evaluation metric. In an illustrative example, a first environmental evaluation model is trained to output a continuous value (e.g., using a first training target), wherein the continuous value output is then binned to a discrete value (e.g., as described in S300). A second environmental evaluation model is trained using the discrete bin value as the second training target (e.g., the second environmental evaluation model is trained to directly output the discrete bin value based on the same or different inputs as the first environmental evaluation model). The second environmental evaluation model can use the same or different model inputs as the first environmental evaluation model (e.g., the first environmental evaluation model uses attribute values as model inputs, the second environmental evaluation model uses property measurements).

Additionally or alternatively, the training data can be simulated training data and/or determined based on simulated data (e.g., wherein the simulated data is generated manually or automatically). The simulated training data can include simulated training properties, simulated training inputs, and/or simulated training targets (e.g., targets determined based on simulated property outcome data). The training data used to train the model can be a combination of historical and simulated training data, only historical training data, or only simulated training data. Using simulated training data can provide an expanded training dataset which can increase statistical significance, can reduce biases in model training (by adjusting the distribution of training properties), and/or otherwise improve the model training. In a first example, the simulated data is determined based on historical data. In this example, the simulated training data can be generated such that the distribution of the simulated training data (e.g., the distribution of the simulated training targets) matches the distribution of the historical training data (e.g., the distribution of the historical training targets). Alternatively, the simulated training data can be generated such that the distribution of the simulated training data is adjusted relative to the historical training data—this can reduce biases by ensuring the training data matches a target population distribution. In a second example, the simulated data is determined based on predicted weather and/or hazard data (e.g., weather data adjusted based on climate change predictions). In a specific example, the training data associated with property measurements (e.g., intrinsic property attribute values) remain unchanged while training data associated with weather and/or hazard data (e.g., regional exposure scores, hazard events, training targets, etc.) are adjusted. However, training data can be otherwise simulated.

Conflating data (e.g., data for risks sharing a similar claims class with the hazard, such as house fire claims for wildfire analysis) can be removed from the training data (e.g., removing the corresponding property from the set of training properties), treated as a false positive dataset, adjust the corresponding training targets (e.g., from a positive claim occurrence to no claim occurrence), and/or be otherwise managed. Conflating data can be identified using data labels (e.g., claims associated with a ‘house fire’ are classified as conflating data), using statistical methods (e.g., outliers, determining a probability that a datapoint is conflating, etc.), comparing data between properties (e.g., a rare datapoint relative to neighboring properties), and/or any other suitable data classification and/or identification method.

The environmental evaluation model ingests the training inputs for each training property and outputs: one or more evaluation metrics for the property; a value which can then be converted into the evaluation metric; a combination of evaluation metrics; a model selection and/or model adjustment (e.g., depending on a key metric, a selected hazard, available data, and/or other information); a key attribute (S600), and/or other metric relevant to the evaluation metric (as described in S400).

To drive model training, the training targets (e.g., ground truth data) for each of the set of training properties can be compared to the environmental evaluation model outputs. In a first variant, the hazard output is directly comparable to the training target for each training property. In a first example, both the environmental evaluation model output and the training target are binary values (e.g., binary claim occurrence). In a second example, both the environmental evaluation model output and the training target are continuous values (e.g., loss amount). In a second variant, the environmental evaluation model output is post-processed (e.g., using a second model) to enable comparison to training target. In a first example, the environmental evaluation model output is non-binary (e.g., continuous, discrete, class, etc.) while the training target is binary. The environmental evaluation model output can be post-processed using a classifier or other model to classify the output as a binary value, which can then be directly compared to the training target. In an illustrative example, the environmental evaluation model outputs a probability of claim occurrence, which is then classified to a binary claim occurrence value (e.g., a greater than 50% claim occurrence probability is classified as a filed claim).

However, the environmental evaluation model can be otherwise trained.

The method can optionally include determining a key attribute S600. S600 can function to explain an evaluation metric (e.g., what attribute(s) are causing the environmental evaluation model to output an evaluation metric indicating a high or low probability of filing a claim). S600 can occur automatically (e.g., for each property), in response to a request, when an evaluation metric falls below or rises above a threshold, and/or at any other time.

S600 can use explainability and/or interpretability techniques to identify property attributes and/or attribute interactions that had the greatest effect in determining a given evaluation metric. The key attribute(s) and/or values thereof can be provided to a user (e.g., to explain why the property is vulnerable or at increased or decreased risk), used to identify errors in the data, used to identify ways of improving the model, and/or otherwise used. S600 can be global (e.g., for one or more environmental evaluation models used in S400) and/or local (e.g., for a given property and/or property attribute values). S600 can include any interpretability method, including: local interpretable model-agnostic explanations (LIME), Shapley Additive exPlanations (SHAP), Ancors, DeepLift, Layer-Wise Relevance Propagation, contrastive explanations method (CEM), counterfactual explanation, Protodash, Permutation importance (PIMP), L2X, partial dependence plots (PDPs), individual conditional expectation (ICE) plots, accumulated local effect (ALE) plots, Local Interpretable Visual Explanations (LIVE), breakDown, ProfWeight, Supersparse Linear Integer Models (SLIM), generalized additive models with pairwise interactions (GA2Ms), Boolean Rule Column Generation, Generalized Linear Rule Models, Teaching Explanations for Decisions (TED), surrogate models, attribute summary generation, and/or any other suitable method and/or approach. In an example, one or more high-lift attributes for a property evaluation metric determination are returned to a user. Any of these interpretability methods can alternatively or additionally be used in selecting attributes in S200. However, one or more key attributes can be otherwise determined.

All or a portion of the models discussed above can be debiased (e.g., to protect disadvantaged demographic segments against social bias, to ensure fair allocation of resources, etc.), such as by adjusting the training data (e.g., adjusting the distribution of training property locations, attribute values, etc.), adjusting the model itself, adjusting the training methods, adjusting attribute selection, and/or otherwise debiased. In a specific example, using claim occurrence and/or claim frequency data (rather than loss amount) can reduce bias in model training. Methods used to debias the training data and/or model can include: disparate impact testing, data pre-processing techniques (e.g., suppression, massaging the dataset, apply different weights to instances of the dataset), adversarial debiasing, Reject Option based Classification (ROC), Discrimination-Aware Ensemble (DAE), temporal modelling, continuous measurement, converging to an optimal fair allocation, feedback loops, strategic manipulation, regulating conditional probability distribution of disadvantaged sensitive attribute values, decreasing the probability of the favored sensitive attribute values, training a different model for every sensitive attribute value, and/or any other suitable method and/or approach. Additionally or alternatively, bias can be reduced using any interpretability method (e.g., an example is described in S340).

### 5. Illustrative Examples

In an illustrative example of calculating a vulnerability score, a vulnerability model can be trained using a set of training properties historically exposed to a given hazard. In the case of wildfire, properties within a threshold radius of one or more wildfires can be selected as the set of training properties; in the case of hail, properties within a region historically exposed to hail and/or exposed to a specific hailstorm can be selected as the set of training properties. The model can be trained to ingest attribute values for a property and output a claim filing probability, where the claim filing probability correlates with the claim filing historical data of that property in the training set. Thus, the vulnerability score for the given hazard (e.g., the claim filing probability or a binned score based on the probability) can represent a risk of a claim filing for a property given that the property is exposed to that hazard.

In an illustrative example of calculating a risk score, a risk model can be trained using a set of training properties which are not exclusively properties with confirmed or inferred exposure to a given hazard. The properties can instead be based on one or more regions (e.g., a region larger than a region exposed to a wildfire). The model can then be trained to ingest attribute values of a property and a regional exposure score (e.g., retrieved from a third-party database; determined using historical weather and/or hazard data for the property location; etc.) and output a claim filing probability, where the claim filing probability correlates with the claim filing historical data of that property in the training set. This training target can be similar to the vulnerability model training, but with a different set of training properties. Thus, the risk score can represent an overall risk of a claim filing, incorporating both regional risk and vulnerability.

In an illustrative example of calculating a mitigated evaluation metric for a property, attribute values ingested by an environmental evaluation model (e.g., a vulnerability model as described in the vulnerability score illustrative example) can be classified as mitigable (e.g., variable) or non-mitigable (e.g., invariable). The attribute values extracted for the property which fall under a mitigable classification (e.g., the attribute values that correspond to a mitigable attribute) are then adjusted. For example, the adjustment can include setting the attribute value for vegetation coverage 0-5 ft from the property to 0, halving the attribute value for vegetation coverage 5-30 ft from the property, adjusting the roof material classification, and/or any other attribute value adjustments. The evaluation metric is then re-calculated with the adjusted attribute values (as well as any non-mitigable attribute values which were not adjusted). The re-calculated evaluation metric can be the mitigated evaluation metric (e.g., a mitigated vulnerability score). Alternatively, the mitigated evaluation metric can be based on the pre-mitigation and post-mitigation evaluation metrics (e.g., a difference between scores, a ratio, etc.).

However, the method can be otherwise performed.

### 6. Use Cases

All or portions of the methods described above can be used for automated property valuation, for insurance purposes, and/or otherwise used.

In a first example, any of the outputs discussed above (e.g., attribute values, evaluation metrics, data generated by the one or more models discussed above, hazard data, attribute value-associated information, etc.) can be provided to one or more property models. The property models can include: an automated valuation model (AVM), which can predict a property value; a property loss model, which can predict damage (or claim) probability and/or severity for a future and/or past hazard event; a claim rejection model, which can predict a probability of claim rejection; and/or any other suitable model.

In a second example, the outputs can be provided to an endpoint (e.g., shown to a property buyer, shown to another user, etc.).

In a third example, the outputs can be used to identify a group of properties and/or modify property groupings. In a first specific example, a targeted list of properties (e.g., a subset of an insurance portfolio) can be identified in a high regional exposure score region (e.g., a high likelihood of hazard exposure) that have low mitigated vulnerability scores (e.g., a desirable vulnerability rating with a lower probability of claim occurrence and/or damage). In a second specific example, properties can be grouped using one or more unmitigated evaluation metric(s) and then re-grouped using one or more mitigated evaluation metric(s), wherein the properties that switch groups (e.g., from a high underwriting risk group to a low underwriting risk group) are provided to a user. In a third specific example, a targeted list of properties can be identified that have changed their vulnerability score over time (e.g., wherein properties with a decrease in vulnerability score may be eligible for an additional credit or lower insurance premium, whereas properties with a positive change may necessitate an underwriting action; or vice versa).

In a fourth example, the outputs can be used to determine a set of mitigation measures for the property (e.g., high-impact mitigation measures that change the evaluation metric above a threshold amount). In an illustrative example, an unmitigated evaluation metric can be compared to each of a set of mitigated evaluation metrics, wherein each mitigated evaluation metric corresponds to a different mitigation measure, to determine one or more high-impact mitigation measures (e.g., with the largest difference between the unmitigated and mitigated evaluation metrics). However, all or portions of the methods described above can be otherwise used.

Different processes and/or elements discussed above can be performed and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Variants can include any combination of variants and/or include any other model. Any model can include: an equation, a regression, a neural network, a classifier, a lookup table, a set of rules, a set of heuristics, and/or be otherwise configured.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A system, comprising:
a user interface configured to:
receive an identifier for a geographic location;
return an evaluation metric for the geographic location; and
return a predicted evaluation metric for the geographic location;
a processing system, configured to:
retrieve, from a database, a measurement depicting the geographic location based on the identifier;
for each attribute in a set of attributes:
using an image segmentation model, determining a segmentation mask based on the measurement;
using the segmentation mask, identifying pixels of the measurement corresponding to the attribute;
determining a measurement segment based on the identified pixels; and
using an attribute model, extracting an attribute value for the attribute based on the measurement segment;
using an environmental evaluation model, determining the evaluation metric based on the attribute value for each attribute in the set of attributes;
determining a classification for each attribute in the set of attributes;
determining a predicted attribute value for each attribute in the set of attributes based on the classification for the respective attribute; and
using the environmental evaluation model, determining the predicted evaluation metric based on the predicted attribute values.

2. The system of claim 1, wherein the image segmentation model comprises a semantic segmentation model, wherein the segmentation mask comprises a semantic segmentation mask.

3. The system of claim 1, wherein the environmental evaluation model comprises a machine learning model trained to predict a non-binary evaluation metric for each of a set of training properties using binary data for the respective training property.

4. The system of claim 1, wherein the environmental evaluation model is trained using training data comprising weather-related data, wherein the environmental evaluation model does not determine the evaluation metric based on weather-related data associated with the geographic location.

5. The system of claim 4, wherein weather-related data comprises at least one of a wildfire region, a flood region, or a hail region.

6. The system of claim 4, further comprising:
determining a regional hazard exposure metric for the geographic location based on the weather-related data associated with the geographic location; and
determining an overall evaluation metric based on the regional hazard exposure metric and the attribute values.

7. The system of claim 1, wherein the processing system is further configured to:
determine a high-lift attribute from the set of attributes based on an explainability value extracted from the environmental evaluation model; and
return the high-lift attribute to the user interface.

8. The system of claim 1, wherein, determining the classification for each attribute in the set of attributes comprises classifying each attribute in the set of attributes as a variable attribute or an invariable attribute.

9. The system of claim 8, wherein determining the predicted attribute value for each attribute in the set of attributes comprises:
for each attribute classified as an invariable attribute, the predicted attribute value for the attribute comprises the attribute value; and
for each attribute classified as a variable attribute, the predicted attribute value for the attribute comprises a predetermined value assigned to the attribute.

10. The system of claim 1, wherein the measurement comprises a digital surface model.

11. A method, comprising:
determining an image depicting a geographic location;
extracting features from the image using a feature extractor;
identifying a component depicted in the image based on the extracted features;
using an attribute model, determining an attribute value for an attribute associated with the identified component based on the image;
using an environmental evaluation model, determining an evaluation metric for the geographic location based on the attribute value;
determining a predicted attribute value for the attribute based on a classification of the attribute as a variable attribute; and
using the environmental evaluation model, determining a predicted evaluation metric based on the predicted attribute value.

12. The method of claim 11, further comprising:
identifying a second component depicted in the image; and
determining a second attribute value for a second attribute associated with the identified second component based on the image, wherein the second attribute value is classified as an invariable attribute;
wherein the evaluation metric is further determined based on the second attribute value; wherein the predicted evaluation metric is further determined based on the second attribute value.

13. The method of claim 11, wherein the environmental evaluation model comprises a trained machine learning model.

14. The method of claim 13, wherein the environmental evaluation model is trained using a set of training geographic locations within a region previously exposed to an environmental hazard.

15. The method of claim 11, wherein identifying the component comprises identifying pixels of the image corresponding to the component, wherein the attribute value is determined based on the identified pixels.

16. The method of claim 11, wherein determining the evaluation metric for the geographic location comprises: predicting a continuous evaluation metric based on the attribute value using the environmental evaluation model; and converting the continuous evaluation metric to a discrete evaluation metric using a classifier, wherein the classifier is trained such that discrete evaluation metrics corresponding to a set of training geographic locations have a predetermined distribution.

17. The method of claim 11, wherein the evaluation metric for the geographic location is not determined based on historical environmental hazard data associated with the geographic location.

18. The method of claim 11, wherein the component comprises a roof, wherein the attribute comprises roof complexity.

29. The method of claim 11, wherein the component comprises vegetation, wherein the attribute comprises vegetation coverage.

20. The method of claim 1, further comprising identifying a set of geographic locations based on the predicted evaluation metric for each geographic location in the set of geographic locations.
